(19) United States
(12) Patent Application Publication
(10) Pub. No.: US 2009/0020638 A1
(43) Pub. Date: Jan. 22, 2009

(54) Grinding Tool with a Coating

(76) Inventors: Norbert Becker, Rottenbach (DE); Thomas Sontgen, Duisburg (DE); Sigrid Thanner, Schmidgaden (DE); Kurt Tischler, Erlangen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/280,049

(22) PCT Filed: Jan. 17, 2007
(86) PCT No.: PCT/EP2007/050430

§ 371 Date: Aug. 20, 2008

(30) Foreign Application Priority Data
Feb. 20, 2006 (DE) 10 2006 008 115.3

(51) Int. Cl. B02C 4/30; B02C 17/20; C25D 5/24

(52) U.S. Cl. 241/291; 241/184; 241/293; 241/300; 205/110

(57) ABSTRACT

In order to increase the service life of a grinding tool (14, 16, 24a, 24b), it is coated with a wear-resistant material, wherein the coating (30, 301) has a ductile metallic parent material (32) with hard particles (34) embedded therein.

### CROSS-REFERENCE TO RELATED APPLICATIONS

This application is a U.S. national stage application of International Application No. PCT/EP2007/050430 filed Jan. 17, 2007, which designates the United States of America, and claims priority to German application number 10 2006 008 115.3 filed Feb. 20, 2008, the contents of which are hereby incorporated by reference in their entirety.

### TECHNICAL FIELD

The invention relates to a grinding tool for the grinding of rock or stone-like material, with a coating consisting of a wear-resistant material, and to a method for producing such a grinding tool.

### BACKGROUND

In cement production or in mining, various mills, such as, for example, tube mills, roller crushers, roller mills and roller press mills, are used for comminution and grinding of particularly hard material, such as ores and rocks. This leads to a high wear of these mills, designated in general here as grinding tools, which entails a frequent costly exchange of the grinding tools. A grinding tool is also understood as meaning individual subcomponents of such mills which come into direct contact with the grinding stock and cooperate in the comminution of the latter.

In mining, for example, tube mills are used which consist of a cylindrical drum rotating about its longitudinal axis. Grinding bodies, such as, for example, grinding balls, are also sometimes contained in the drum. The grinding stock is supplied on one side of the mill and is comminuted and ground in the drum by the grinding balls while it is moving toward the outflow on the opposite side. Armor plates screwed to the drum wall form the inner lining of the drum. In addition to the armor plates, webs or strips designed in the manner of drivers are fastened to the drum wall. During the rotation of the tube mill, the grinding stock, together with the grinding balls, is lifted by the webs and then slides down again. The grinding stock is at the same time comminuted.

In cement works, roller crushers, roller mills and roller press mills are mainly used. All these types of mills comprise at least two contradirectional rollers or cylinders between which the grinding stock is pressed. In a roller press mill, one of the rollers is usually stationary. The other roller is movable and is pressed against the stationary roller with the aid of an external force. Pressing generates the pressure necessary for grinding. In this case, the coarse grinding stock located between the rollers is crushed until it has the desired fineness.

Customary practice for protecting the grinding tools coming into contact with the coarse grinding stock against wear is, for example, to weld a hard layer on the grinding tool. However, such welded-on hard layers are sensitive to overload and continuous stress.

EP 0 399 058 A1 describes a roller or cylinder mill with two cylinders, to the surface areas of which is applied a wear-resistant coating which is formed by a winding consisting of profile ribbon.

### SUMMARY

The service life and therefore the lifetime of a grinding tool can be increased in order, in particular, to make more cost-effective operation possible.

According to an embodiment, a grinding tool for the comminution of rock or stone-like material, may comprise a coating consisting of a wear-resistant material, wherein the coating comprises a ductile metallic basic material with a Vickers hardness of a maximum of about 180-230 HV₀₁ and with hard material particles embedded in it.

According to a further embodiment, the fraction of the basic material may be between about 65% by volume and 95% by volume. According to a further embodiment, the basic material may be nickel or a nickel alloy. According to a further embodiment, cobalt can be provided as the alloying constituent. According to a further embodiment, the cobalt fraction in the alloy may be up to about 12% by volume, in particular between about 2% by volume and 5% by volume. According to a further embodiment, the basic material may be bronze. According to a further embodiment, the basic material may be cobalt. According to a further embodiment, the fraction of hard material particles can be between about 5% by volume and 35% by volume. According to a further embodiment, the hard material particles used can be boron carbide, and/or tungsten carbide, and/or silicon carbide, and/or carbon particles. According to a further embodiment, the hard material particles may have a size of between 10 nm and 1 μm, in particular of between 50 nm and 500 nm. According to a further embodiment, the thickness of the coating can be in the range of between 0.5 mm and 6 mm. According to a further embodiment, the coating can be applied electrolytically. According to a further embodiment, a hard coating consisting in particular of synthetic diamond can be applied to the coating. According to a further embodiment, the hard coating may have a thickness of up to 50 μm. According to a further embodiment, the hard coating may be applied by means of a CVD method. According to a further embodiment, the grinding tool can be an armor plate or a driver strip for a tube mill. According to a further embodiment, the grinding tool may be a grinding ball for a tube mill. According to a further embodiment, the grinding tool can be a roller for a roller mill.

According to another embodiment, a method for producing such a grinding tool as mentioned above may comprise the step of applying the coating electrolytically.

### BRIEF DESCRIPTION OF THE DRAWINGS

Exemplary embodiments of the invention are explained in more detail below with reference to the drawing. In this, in each case in diagrammatic and highly simplified illustrations,

FIG. 1 shows diagrammatically the set-up of a tube mill with grinding stock contained in it,

FIG. 2 shows a part section through a tube mill,

FIG. 3 shows diagrammatically the set-up of a roller press mill,

FIG. 4 shows a coating of a grinding tool, and

FIG. 5 shows a coating of a grinding tool with a hard coating applied to the coating.

Similarly acting parts are given the same reference symbols in the individual figures.

### DETAILED DESCRIPTION

According to an embodiment, a grinding tool may comprise a coating consisting of a wear-resistant material, the coating comprising a ductile metallic material with hard material particles embedded in it.

A ductile metallic basic material is understood in this context to mean a comparatively soft metallic basic material which has a Vickers hardness of a maximum of about 180-230 HV₀₁. The determination of hardness according to Vickers may be gathered from the standard DIN EN ISO 6507. By contrast, the embedded hard material particles have a markedly higher hardness, for example a hardness higher by more than the factor 2 than the basic material.

By a ductile material being combined with the hard material particles embedded in it, the components are provided with a coating which withstands the extreme loads. Owing to the ductility, there is, in comparison with a continuously hard and brittle coating, a markedly lower risk that, during operation, the coating is damaged and cracks or microcracks occur, which would quickly lead to undesirable pronounced corrosion on account of the highly corrosive surroundings. Also, on account of the high ductility, the risk of a chipping off of fragments of the coating under mechanical load is markedly lower than in the case of a brittle coating. At the same time, due to the embedded hard material particles, very high abrasion resistance and consequently a virtually very high surface hardness are obtained, so that a long lifetime is achieved even under high mechanical loads and high abrasive forces.

According to various embodiments, the basic material is nickel or a nickel alloy. The particular advantage of the nickel coating for such components is its corrosion resistance. Moreover, in particular, nickel alloys have a high resistance to stress corrosion cracking.

Expediently, the alloying constituent is cobalt. Furthermore, preferably, the cobalt percentage can be up to about 12% by volume, in particular in the range of between about 2% by volume and 5% by volume.

According to a further embodiment, the basic material is bronze. On account of its high toughness and its corrosion resistance, bronze is particularly suitable for use as a ductile basic material of the wear-resistant coating.

According to a third embodiment, the basic material is cobalt which is likewise distinguished by its toughness.

Expediently, the percentage of hard material particles is between about 5% by volume and 35% by volume. According to experience, this percentage of hard material particles gives rise to a sufficient hardness of the coating, so that the coating fulfils the requirements with regard to wear resistance.

The hard material particles used in this case can be boron carbide, tungsten carbide, silicon carbide or carbon particles. Carbon is understood in this context to mean, in particular, a diamond or solid graphite modification. With boron carbide and tungsten carbide, ceramic particles are used, the hardness of which is almost as high as the hardness of diamond.

Furthermore, there is provision for the hard material particles to have a size of between 10 nm and 1 μm, in particular between 50 nm and 500 nm. Nano-scale particles can be embedded particularly effectively into the basic material.

The thickness of the coating can be preferably in the range of between about 0.5 mm and 6 mm. It has been shown that the coating with such a layer thickness satisfies the high requirements particularly well.

In order to produce a high-quality coating which adheres effectively and permanently, the coating may be advantageously applied electrolytically. To form the coating, therefore, the component to be coated is dipped into one or more electroplating baths. The anode used is an electrode consisting of the basic material and the cathode used is the grinding tool to be coated. The hard materials are in this case added to the electroplating bath, so that they travel together with the metal ions of the anode to the component to be coated and are deposited there together with the metal ions.

For grinding tools which are exposed to an extremely high mechanical load, in an expedient development, the application of a hard coating consisting, in particular, of synthetic diamond is provided on the ductile coating. In this case, a continuous further layer of diamond is applied to the basic material layer having the hard material particles embedded in it. Such a diamond coating has an extremely high leak tightness, very good thermal conductivity, an extremely high hardness and very low abrasion. Owing to a hard coating of this type, the service lives of the tool can be increased by more than double.

The diamond coating in this case has a thickness of up to about 50 μm. Since, in the case of a hard coating, the mechanical properties are ensured mainly by the diamond layer, the thickness of the ductile coating with the hard material particles can be preferably lower, as compared with a coating without the diamond coating. The coating, also to be designated as a basic coating, with the ductile metallic basic material serves in this case in the manner of an adhesion promoter layer, so that the diamond coating can be applied reliably and permanently to the material of the basic body, for example steel or copper. A multilayer set-up of the coating is also possible, in which the basic coating and the hard coating are arranged doubly or multiply one above the other.

The diamond coating may in this case be preferably applied by means of a CVD method (chemical vapor deposition), in order to ensure a reliable and permanent bond with a coating lying beneath it.

An armor plate and/or a driver strip for a tube mill can be preferably provided as a grinding tool to be coated. The armor plates and driver strips are almost constantly in contact with the hard grinding stock when the tube mill is in operation and are therefore subjected to intensive wear, so that, in conventional tube mills, they have to be exchanged about twice a year. This, however, is highly time-consuming. In the exchange of the armor plates, there is a standstill of the tube mill of several days which leads to very high losses as a result of the production stoppage. Tube mills typically have an elongate cylindrical form of construction with a diameter of several meters up to, for example, 30 meters. Tube mills are used for the coarse comminution of rock of, for example, 10 cm up to large lumps of rock or boulders of, for example, 0.5 m. Tube mills have, for example, a throughput of several tons of rock per hour. As compared with conventional coatings, the wear-resistant coating consisting of a metallic material with hard material particles embedded in it makes it possible to have about a doubling of the service life of the tube mill which entails a marked reduction in losses on account of maintenance work.

A further embodiment of a grinding tool which is provided with the coating is a grinding ball of a tube mill. The grinding balls, which crush the grinding stock during the rotation of the tube mill, are likewise exposed to extremely high abrasion. The coating of their surface likewise makes it possible to increase their lifetime markedly.

In a further embodiment, the grinding tool is a roller of a roller mill. In this case, likewise, a prolongation of the service life of the roller of at least double is achieved.

Furthermore, according to an embodiment, in a method for producing such a grinding tool, the coating of the grinding tool may be applied electrolytically. The advantages and refinements listed in terms of the grinding tool can also be transferred accordingly to the method and the plant.

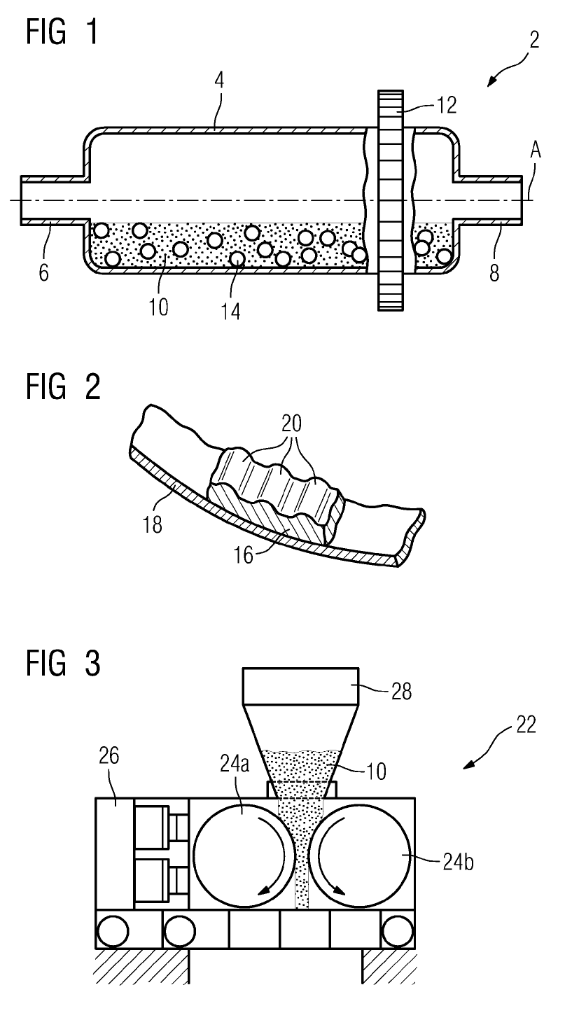

Tube mills 2 are often used in mining or in cement works. A tube mill 2 is illustrated diagrammatically in FIG. 1. The mill 2 comprises a drum 4 rotatable about its longitudinal axis A and having an inflow 6 and an outflow 8 for the grinding stock 10. The drum 4 is driven electromagnetically by an annular rotor 12. The inside of the drum 4 contains, in addition to the grinding stock 10, a plurality of grinding balls 14.

The inner lining of the drum 4 is formed by metallic armor plates 16, together with webs 20 extending in the longitudinal direction of the drum 4, as shown in FIG. 2. In the exemplary embodiment, the webs 20 are designed as wave-like elevations on the armor plates 16. Alternatively, the webs 20 are designed as separate components.

The individual armor plates 16 have, for example, a size of 2 m-1 m and are mounted, in particular screwed, on the cylindrical wall 18 of the drum 4. The grinding stock 10 and the grinding balls 14 are raised, during the rotation of the tube mill 2, with the aid of the webs 20.

When the tube mill 2 is in operation, the grinding stock 10 is supplied continuously through the inflow 6 and is conveyed in the direction of the outflow 8. During rotation, on account of their dead weight, the material 10 and grinding balls 14 raised by the corrugations 20 of the armoring 16 fall down, and the material 10 is in this case, inter alia, crushed by the grinding balls 14.

A further mill, a roller press mill 22, which is mainly used for cement production, is illustrated in FIG. 3. In this exemplary embodiment, the roller press mill 22 comprises two rollers 24a, 24b which are driven contradirectionally by a drive device, not shown here. The roller 24b forms a fixed roller, while the roller 24a is pressed against the roller 24b by means of a hydraulic device 26. A shaft 28 is provided for supplying the grinding stock 10 to be comminuted.

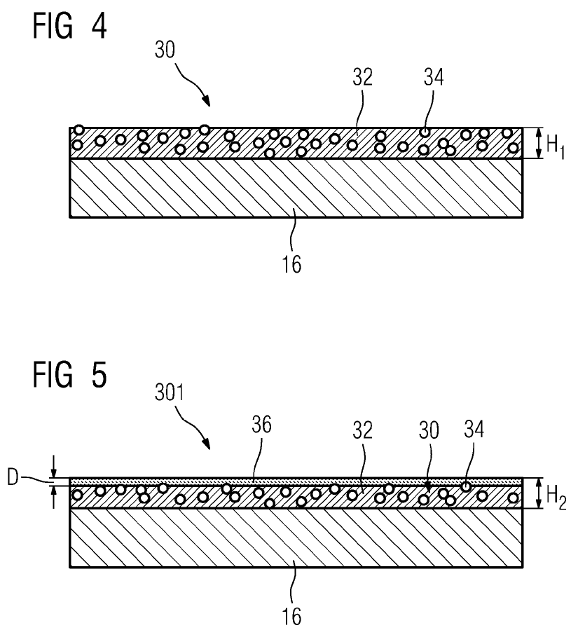

FIG. 4 shows a design variant of a coating 30 which is used for protecting a grinding tool, in this exemplary embodiment an armor plate 16. The wear-resistant coating 30 can likewise be applied to the surface of the grinding balls 14, of the rollers 24a, 24b or of other elements of the mills 2, 22 which are subject to high abrasion. The coating 30 comprises a ductile mechanical basic material 32, such as, for example, pure nickel, a nickel alloy, in particular with cobalt as the alloying constituent, bronze or pure cobalt.

Embedded in the basic material 32 are hard material particles 34, the percentage of which is between about 5% by volume and 35% by volume. The hard material particles 34 have extremely high hardness and consist, for example, of boron carbide, tungsten carbide, silicon carbide, diamond or graphite. The hard material particles 34 have a size in the nanometer range, in this exemplary embodiment of between 50 nm and 500 nm.

The coating 30 amounts to a thickness H₁ of between 0.5 mm and 6 mm, depending on the application.

In a coating 30 with cobalt basic material 32, in particular, hard material particles 34 consisting of tungsten carbide, the percentage of which is about 5-20% by volume, are embedded. The height of this coating 30 is about 3 mm. Such a coating 30 is particularly suitable as a priming surface for the application of a hard coating 36, as described in FIG. 5.

Alternatively, a coating 30 based on a nickel/cobalt alloy 32 is provided, for example a composition of about 70% by volume of nickel, 5% by volume of cobalt and 25% by volume of boron carbide particles 34. The thickness of this coating 30 is up to about 6 mm.

In a third design variant of the composition of the coating 30, bronze is provided as the basic material 32, in which about 20% by volume of hard material particles 34 consisting of boron carbide, silicon carbide or diamond are embedded. This coating 30 is about 4 mm thick.

To apply the coating 30, the grinding tool 14, 16, 24a, 24b to be coated is dipped into an electroplating bath containing an electrolyte solution and is connected as a cathode to a voltage source. Also connected to the voltage source is at least one anode which consists of the basic material 32. The hard material particles 34 are also added to the electrolyte solution. When an external electrical voltage is applied between the cathode and anode, oxidation on the anode takes place, in which positively charged metal ions of the basic material come loose and travel to the negatively charged cathode. They are deposited, together with hard material particles 34, on the cathode surface and thus form the coating 30 of the grinding tool 14, 16, 24a, 24b.

A second design variant of a wear-resistant coating 301 is illustrated in FIG. 5. The coating 301 has an inner coating 30, the basic coating, the composition of which corresponds to that of the coating 30 according to FIG. 4. The basic coating 30 is applied electrolytically to the grinding tool 14, 16, 24a, 24b.

A hard coating 36 consisting, in particular, of synthetic diamond is applied to the basic coating 30. The thickness D of the hard coating 36 amounts up to 50 μm. The basic coating 30 is less thick than the coating 30 according to FIG. 4, so that the overall thickness H₂ of the coating 303 corresponds approximately to the thickness H₁ of the coating 30 in FIG. 4.

The diamond layer 36 is applied, in particular, by means of a CVD method (chemical vapor deposition). In this case, the grinding tool 14, 16, 24a, 24b, already provided with the basic coating 30, has flowing around it a gas which consists of about 90% by volume of hydrogen and 1% by volume of an organic substance, such as methane or acetylene. The gas is activated thermally with the aid of a laser or a plasma, so that a chemical reaction in which the diamond layer 36 is precipitated takes place on the surface of the basic coating 30. In the process, the excess hydrogen suppresses the formation of other carbon modifications, such as, for example, graphite.

1. A grinding tool for the comminution of rock or stone-like material, with a coating consisting of a wear-resistant material, wherein the coating comprises a ductile metallic basic material with a Vickers hardness of a maximum of about 180-230 HV₀₁ and with hard material particles embedded in it.

2. The grinding tool according to claim 1, wherein the fraction of the basic material is between about 65% by volume and 95% by volume.

3. The grinding tool according to claim 1, wherein the basic material is nickel or a nickel alloy.

4. The grinding tool according to claim 1, wherein cobalt is provided as the alloying constituent.

5. The grinding tool according to claim 1, wherein the cobalt fraction in the alloy is up to about 12% by volume, in particular between about 2% by volume and 5% by volume.

6. The grinding tool according to claim 1, wherein the basic material is bronze.

7. The grinding tool according to claim 1, wherein the basic material is cobalt.

8. The grinding tool according to claim 1, wherein the fraction of hard material particles is between about 5% by volume and 35% by volume.

9. The grinding tool according to claim 1, wherein the hard material particles used are one or more selected from the group consisting of boron carbide, tungsten carbide, silicon carbide, and carbon particles.

10. The grinding tool according to claim 1, wherein the hard material particles have a size of between 10 nm and 1 μm or between 50 nm and 500 nm.

11. The grinding tool according to claim 1, wherein the thickness of the coating is in the range of between 0.5 mm and 6 mm.

12. The grinding tool according to claim 1, wherein the coating is applied electrolytically.

13. The grinding tool according to claim 1, wherein a hard coating is applied to the coating.

14. The grinding tool according to claim 13, wherein the hard coating has a thickness of up to 50 μm.

15. The grinding tool according to claim 13, wherein the hard coating is applied by means of a CVD method.

16. The grinding tool according to claim 1, wherein the grinding tool is an armor plate or a driver strip for a tube mill.

17. The grinding tool according to claim 1, wherein the grinding tool is a grinding ball for a tube mill.

18. The grinding tool according to claim 1, wherein the grinding tool is a roller for a roller mill.

19. A method for producing a grinding tool for the comminution of rock or stone-like material, with a coating consisting of a wear-resistant material, wherein the coating comprises a ductile metallic basic material with a Vickers hardness of a maximum of about 180-230 HV₀₁ and with hard material particles embedded in it comprising the step of applying the coating electrolytically.

20. The grinding tool according to claim 1, wherein a hard coating consisting of synthetic diamond is applied to the coating.
